(19) United States
(12) Patent Application Publication
(10) Pub. No.: US 2002/0162459 A1
(43) Pub. Date: Nov. 7, 2002

(54) Edible product compression assembly

(76) Inventor: Bridgett T. Lenox, El Cajon, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/848,939

(22) Filed: May 3, 2001

(51) Int. Cl. A23P 1/00; A23L 1/00

(52) U.S. Cl. 99/349; 99/353

(57) ABSTRACT

A bottom pan having a flat interior bottom surface and a raised peripheral lip terminating in an upfacing lip edge receives a top pan having a flat exterior bottom surface and a side wall terminating in a shoulder. The top pan is removably engagable within the bottom pan such that the top pan shoulder rests upon the bottom pan peripheral lip establishing a fixed space between the interior bottom surface of the bottom pan and the exterior bottom surface of the top pan. A roller assembly is engaged with the top pan in rolling communication such that the roller is movable in controlled linear motion across an inner surface of the top pan to assure uniform and total compression of a soft foodstuff.

### BACKGROUND OF THE INVENTION

1. Field of the Invention

This invention relates generally to food pans and food shaping apparatus and more particularly to a pan for soft foods where it is desired to flatten such foods in a uniform manner.

2. Description of Related Art

The following art defines the present state of this field:

Peirce, U.S. Pat. No. 132,736 discloses the concept of rolling food stuffs with a roller having one or more handles.

Benedict, U.S. Pat. No. 3,010,413 discloses a rolling pin with a sprinkling attachment for powder.

Muller, U.S. Pat. No. 4,426,200 teaches a dual rolling pin with flour dispenser.

Henderson, U.S. Pat. No. 4,828,140 discloses a pan assembly with a lid and central handle.

DeChristopher, U.S. Pat. No. 4,936,686 discloses a roller will ball shaped implement.

Zaveri, U.S. Pat. No. 5,546,850 shows an electric rolling pin for making pizza.

The prior art teaches the use of implements for rolling food stuffs in the preparation for food articles, but does not teach a double pan capable of flattening a food material between two pan bottom surfaces. The present invention fulfills these needs and provides further related advantages as described in the following summary.

### SUMMARY OF THE INVENTION

The present invention teaches certain benefits in construction and use which give rise to the objectives described below.

A bottom pan having. a flat interior bottom surface and a raised peripheral lip terminating in an upfacing lip edge receives a top pan having a flat exterior bottom surface and a side wall terminating in a shoulder. The top pan is removably engagable within the bottom pan such that the top pan shoulder rests upon the bottom pan peripheral lip establishing a fixed space between the interior bottom surface o f the bottom pan and the exterior bottom surface of the top pan. A roller assembly is engaged with the top pan in rolling communication such that the roller is movable in controlled linear motion across an inner surface of the top pan to assure uniform and total compression of a soft foodstuff.

A primary objective of the present invention is to provide an apparatus and method of use of such apparatus that provides advantages not taught by the prior art.

Another objective is to provide such an invention capable of uniform compression of a foodstuff.

A further objective is to provide such an invention capable of simple and inexpensive production.

A still further objective is to provide such an invention capable of very simple operation and use.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a side elevation exploded view of the invention;

FIG. 2 is a side elevation view thereof, as assembled.

FIG. 3 is a top plan view of a top pan thereof;

FIG. 4 is a bottom plan view of a bottom pan thereof, and

FIG. 5 is a perspective view thereof.

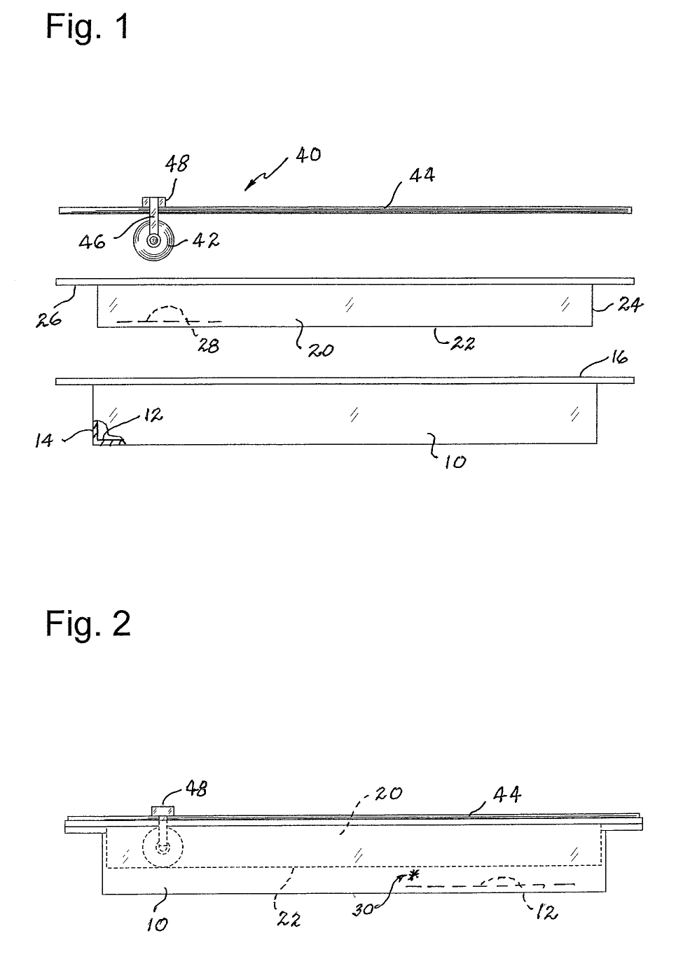

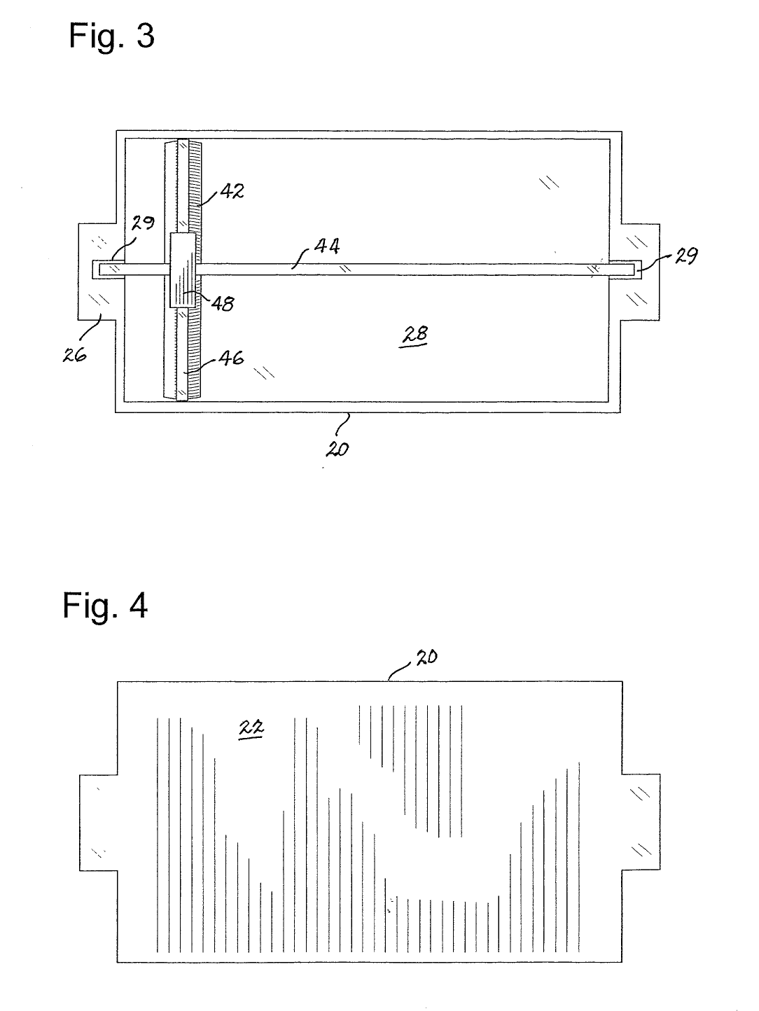

### DETAILED DESCRIPTION OF THE INVENTION

The above-described drawing figures illustrate the invention in at least one of its preferred embodiments, which is further defined in detail in the following description.

The present invention is a food pan apparatus for providing uniform flattening of a soft food material (not shown) which comprises a bottom pan 10 having a flat interior bottom surface 12 and a raised peripheral lip 14 terminating in an upfacing lip edge 16, and a top pan 20 having a flat exterior bottom surface 22 and a side wall 24 terminating in a shoulder 26. These pans may be made of any common pan material but the top pan 20 is preferably made of a thin sheet metal or plastic such that the bottom surface 22 of the top pan 20 is somewhat flexible.

The top pan 20 is removably engagable within the bottom pan 10, as shown in FIG. 2. The top pan shoulder 26 rests upon the bottom pan lip edge 16 establishing a fixed space 30 between the interior bottom surface 12 of the bottom pan 10 and the exterior bottom surface 22 of the top pan 20. The space 30 receives a foodstuff and is compressed between the two pans. A roller assembly 40 is engaged with the top pan 20 in rolling communication such that a roller 42 is movable in controlled linear motion across an inner surface 28 of the top pan 20. The roller assembly 40 includes a linear strut 44 adapted for receiving the roller 42 which is rotationally mounted on a roller bracket 46. The roller bracket 46 is engaged with the linear strut 44 for movement restrained thereby. The roller assembly 40 further comprises a handle 48 extending in opposition to the roller 42 for manually moving -the roller bracket 44 with the roller 42 along the linear strut 44. Preferably, the shoulder 26 of the top pan is adapted for receiving the linear strut 44 within opposing strut grooves 29 at opposing ends of the shoulder.

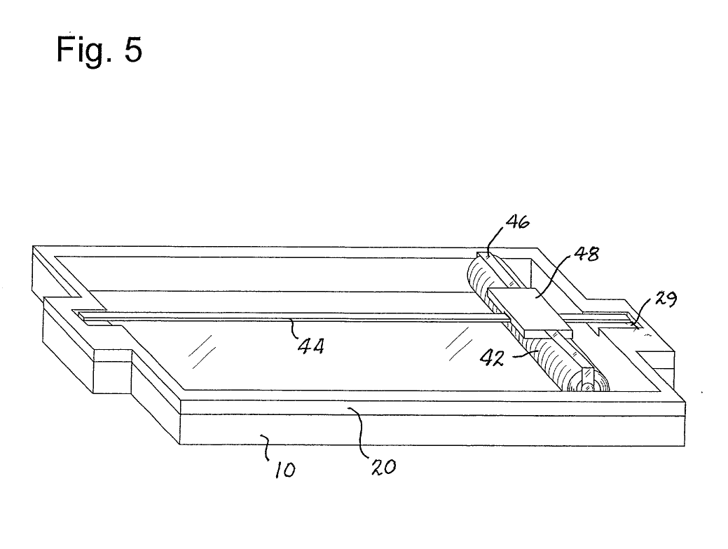

In use, a foodstuff such as a candy or a cake is place within the interior of the bottom pan and the top pan is then placed into the bottom pan, as shown in FIGS. 2 and 5. The top pan is pressed downwardly to compress the foodstuff and the roller is manually traversed within the top pan from end to end until the foodstuff is uniformly compressed between the pans. The top pan may be inverted to form a cover for the bottom pan when the assembly is stored.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A food pan apparatus for providing uniform flattening of a soft food material which comprises: a bottom pan having a flat interior bottom surface and a raised peripheral lip terminating in an upfacing lip edge; a top pan having a flat exterior bottom surface and a side wall terminating in a shoulder, the to pan removably engagable within the bottom pan such that the top pan shoulder rests upon the bottom pan peripheral lip establishing a fixed space between the interior bottom surface of the bottom pan and the exterior bottom surface of the top pan; and a roller assembly engaged with the top pan in rolling communication such that the roller is movable in controlled linear motion across an inner surface of the top pan.

2. The apparatus of claim I wherein the roller assembly comprises a linear strut and a roller rotationally mounted on a roller bracket, the roller bracket engaged with the linear strut for moving therealong.

3. The apparatus of claim 2 wherein the roller assembly further comprises a handle extending in opposition to the roller for manually moving the roller bracket along the linear strut.

4. The apparatus of claim 3 wherein the shoulder of the top wall receives the linear strut within opposing strut grooves at opposing ends of the top wall.
